(19) United States
(12) Patent Application Publication
(10) Pub. No.: US 2016/0274837 A1
(43) Pub. Date: Sep. 22, 2016

(54) MANAGEMENT UNIT, INFORMATION PROCESSING SYSTEM, AND NON-TRANSITORY COMPUTER READABLE MEDIUM

(71) Applicant: FUJI XEROX CO., LTD., Tokyo (JP)

(72) Inventors: Yoshimi UEZU, Kanagawa (JP); Satoshi KAMIYA, Kanagawa (JP); Hiromoto ANDO, Kanagawa (JP); Chie OHARA, Kanagawa (JP)

(73) Assignee: FUJI XEROX CO., LTD., Tokyo (JP)

(21) Appl. No.: 14/809,705

(22) Filed: Jul. 27, 2015

(30) Foreign Application Priority Data
Mar. 20, 2015 (JP) 2015-058636

(51) Int. Cl. G06F 3/12

(52) U.S. Cl. CPC G06F 3/1236; G06F 3/1231; G06F 3/1287; G06F 3/1286; G06F 3/1208

(57) ABSTRACT

A management unit communicates with an image forming apparatus via a first communication path and communicates with an information processing apparatus receiving an operation for maintenance for the image forming apparatus, via a second communication path. The management unit includes a memory for storing specifying information for specifying an image forming apparatus, in association with identification information for identifying the image forming apparatus in local communication between the information processing apparatus and the image forming apparatus. The management unit also includes a specifying-information acquiring unit acquiring the specifying information of an image forming apparatus which is a maintenance target, from an identification-information request signal transmitted from the information processing apparatus via the second communication path, and a transmitting unit transmitting the identification information stored in the memory in association with the acquired specifying information, to the information processing apparatus via the second communication path.

### CROSS-REFERENCE TO RELATED APPLICATIONS

This application is based on and claims priority under 35 USC 119 from Japanese Patent Application No. 2015-058636 filed Mar. 20, 2015.

### BACKGROUND

(i) Technical Field

The present invention relates to a management unit, an information processing system, and a non-transitory computer readable medium.

(ii) Related Art

FIG. 10 is a diagram illustrating an exemplary information processing system 20 of the related art, which manages image forming apparatuses 50-1 to 50-n. In the information processing system 20, a management unit 30 which is, for example, an information processing apparatus operated by a supplier supplying the image forming apparatuses 50-1 to 50-n manages the image forming apparatuses 50-1 to 50-n. In accordance with a maintenance request signal transmitted from at least one of the image forming apparatuses 50-1 to 50-n (hereinafter referred to as an image forming apparatus 50), the management unit 30 transmits maintenance information with which the image forming apparatus 50 performs a maintenance operation, to the image forming apparatus 50 which has transmitted the maintenance request signal.

A personal computer 40 is, for example, an information processing apparatus used by a user using the image forming apparatuses 50-1 to 50-n. When the user wants to cause an image forming apparatus 50 to perform a maintenance operation, the personal computer 40 requests an Internet Protocol (IP) address (global IP address) of the image forming apparatus 50, which is used to communicate with the image forming apparatus 50 via the Internet 85, from the management unit 30. When the personal computer 40 obtains the global IP address from the management unit 30, the personal computer 40 uses the global IP address to transmit a maintenance-request transmission instruction to the image forming apparatus 50. The maintenance-request transmission instruction is a signal to instruct the image forming apparatus 50 to transmit a maintenance request signal to the management unit 30.

The image forming apparatuses 50-1 to 50-n transmit maintenance request signals to the management unit 30 on the basis of a predetermined condition (for example, every predetermined period). In addition, the image forming apparatuses 50-1 to 50-n transmit maintenance request signals to the management unit 30 in accordance with maintenance-request transmission instructions transmitted from the personal computer 40. When the image forming apparatuses 50-1 to 50-n receive maintenance information from the management unit 30, the image forming apparatuses 50-1 to 50-n perform maintenance operations on the basis of the received maintenance information.

The management unit 30 communicates with the image forming apparatuses 50-1 to 50-n via a communication path, such as a freedom of mobile multimedia access (FOMA) network 90, different from the Internet 85. The reason for this is as follows. As described above, the image forming apparatuses 50-1 to 50-n automatically transmit maintenance request signals on the basis of the predetermined condition, and receive the maintenance information from the management unit 30. If these types of communication are performed via the Internet 85, communication is performed through a barrier for security, such as a firewall 80. Thus, for example, complicated processes are performed to perform the communication, and the communication which is automatically performed is unfavorable to security.

The personal computer 40 and the image forming apparatuses 50-1 to 50-n are included in a local area network (LAN) constituted by apparatuses connected to each other via a bus 60 which is connected to the Internet 85 via a gateway 70. The management unit 30 is connected to the Internet 85.

As described above, when the personal computer 40 is to transmit a maintenance-request transmission instruction to an image forming apparatus 50, the personal computer 40 obtains the global IP address from the management unit 30, and communicates with the image forming apparatus 50 via the Internet 85. This is because the management unit 30 manages global IP addresses and does not manage IP addresses (local IP addresses) for LAN communication.

### SUMMARY

According to an aspect of the invention, there is provided a management unit which communicates with at least one image forming apparatus via a first communication path and which communicates with an information processing apparatus via a second communication path. The information processing apparatus receives an operation for maintenance for the at least one image forming apparatus. The management unit includes a memory, a specifying-information acquiring unit, and a transmitting unit. The memory is used to store specifying information and identification information in such a manner that the specifying information and the identification information are associated with each other. The specifying information is information for specifying the at least one image forming apparatus. The identification information is information for identifying the at least one image forming apparatus in local communication between the information processing apparatus and the at least one image forming apparatus. The specifying-information acquiring unit acquires the specifying information from an identification-information request signal transmitted from the information processing apparatus via the second communication path. The specifying information is information for specifying the at least one image forming apparatus which is a target for the maintenance. The transmitting unit transmits the identification information to the information processing apparatus via the second communication path. The identification information is stored in the memory in association with the specifying information acquired by the specifying-information acquiring unit.

### BRIEF DESCRIPTION OF THE DRAWINGS

Exemplary embodiment of the present invention will be described in detail based on the following figures, wherein:

FIG. 1 is a diagram illustrating an exemplary information processing system which manages image forming apparatuses, according to an exemplary embodiment of the present invention;

FIG. 2 is a functional block diagram illustrating a management unit according to the exemplary embodiment of the present invention;

FIG. 3 is a diagram illustrating information stored in a local-IP-address memory in the management unit according to the exemplary embodiment of the present invention;

FIG. 4 is a block diagram illustrating the hardware configuration of the management unit according to the exemplary embodiment of the present invention;

FIG. 5 is a functional block diagram illustrating a personal computer according to the exemplary embodiment of the present invention;

FIG. 6 is a block diagram illustrating the hardware configuration of the personal computer according to the exemplary embodiment of the present invention;

FIG. 7 is a functional block diagram illustrating the configuration of an image forming apparatus according to the exemplary embodiment of the present invention;

FIG. 8 is a block diagram illustrating the hardware configuration of the image forming apparatus according to the exemplary embodiment of the present invention;

FIG. 9 is a sequence chart of operations in the information processing system according to the exemplary embodiment of the present invention; and

FIG. 10 is a diagram illustrating an exemplary information processing system of the related art, which manages image forming apparatuses.

### DETAILED DESCRIPTION

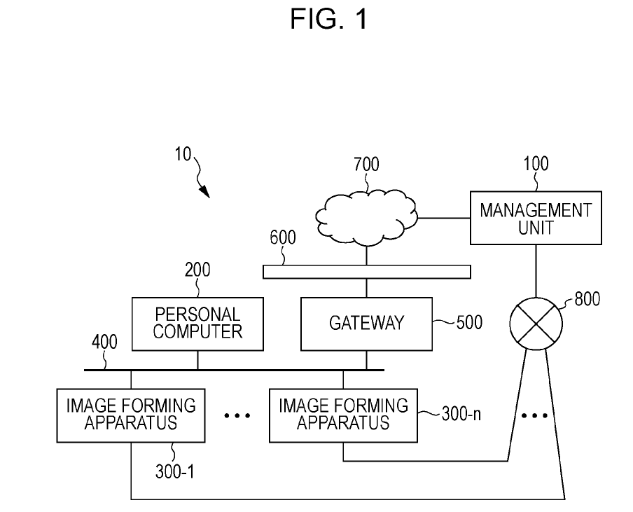

FIG. 1 is a diagram illustrating an exemplary information processing system 10 which manages image forming apparatuses 300-1 to 300-n, according to an exemplary embodiment of the present invention. A personal computer 200 and the image forming apparatuses 300-1 to 300-n are included in a local area network (LAN) constituted by apparatuses connected to each other via a bus 400 which is connected to the Internet 700 via a gateway 500. A firewall 600 is provided between the gateway 500 and the Internet 700. A management unit 100 is connected to the Internet 700.

The management unit 100 communicates with the image forming apparatuses 300-1 to 300-n via a communication path, such as a freedom of mobile multimedia access (FOMA) network 800, different from the Internet 700. The reason for this is as follows. The image forming apparatuses 300-1 to 300-n transmit maintenance request signals to request maintenance information, to the management unit 100 on the basis of a predetermined condition (such as every predetermined period), and receive maintenance information from the management unit 100. If these types of communication are performed via the Internet 700, communication is performed through the firewall 600 provided between the LAN and the Internet 700. Thus, for example, complicated processes are performed to perform the communication, and the communication which is automatically performed is unfavorable to security.

The management unit 100, which is an information processing apparatus operated by a supplier supplying, for example, the image forming apparatuses 300-1 to 300-n, manages the image forming apparatuses 300-1 to 300-n. In accordance with a maintenance request signal transmitted from at least one of the image forming apparatuses 300-1 to 300-n (hereinafter referred to as an image forming apparatus 300), the management unit 100 transmits maintenance information with which the image forming apparatus 300 performs a maintenance operation, to the image forming apparatus 300. In addition, the management unit 100 stores the apparatus ID (specifying information) for specifying an image forming apparatus 300, and the Internet Protocol (IP) address (local IP address) used when the image forming apparatus 300 performs communication through the LAN, in such a manner that the apparatus ID and the IP address are associated with each other.

The personal computer 200 is, for example, an information processing apparatus used by a user using the image forming apparatuses 300-1 to 300-n. When the user wants to cause an image forming apparatus 300 to perform a maintenance operation, the personal computer 200 transmits a local-IP-address request signal (identification-information request signal) including the apparatus ID (specifying information) of the image forming apparatus 300, to the management unit 100, and requests the IP address (local IP address) used to perform LAN communication with the image forming apparatus 300. When the personal computer 200 obtains the local IP address from the management unit 100, the personal computer 200 uses the local IP address to communicate with the image forming apparatus 300, and transmits a maintenance-request transmission instruction to the image forming apparatus 300. The maintenance-request transmission instruction is a signal to instruct the image forming apparatus 300 to transmit a maintenance request signal to the management unit 100.

The image forming apparatuses 300-1 to 300-n transmit maintenance request signals to the management unit 100 on the basis of the predetermined condition (for example, every predetermined period). The image forming apparatuses 300-1 to 300-n transmit maintenance request signals to the management unit 100 in accordance with maintenance-request transmission instructions transmitted from the personal computer 200. When the image forming apparatuses 300-1 to 300-n receive maintenance information from the management unit 100, the image forming apparatuses 300-1 to 300-n perform maintenance operations on the basis of the received maintenance information.

The management unit 100 will be described in detail. In accordance with a maintenance request signal transmitted from an image forming apparatus 300, the management unit 100 transmits maintenance information with which the image forming apparatus 300 performs a maintenance operation, via the FOMA network 800 to the image forming apparatus 300. The maintenance information includes information for setting customer information in the image forming apparatus 300 and information for setting operation information for the image forming apparatus 300.

The management unit 100 stores the apparatus ID (specifying information) for specifying an image forming apparatus 300 and the local IP address for identifying the image forming apparatus 300 in the LAN communication, in such a manner that the apparatus ID and the local IP address are associated with each other. In accordance with a local-IP-address request signal which includes specifying information and which is transmitted from the personal computer 200 via the Internet 700, the management unit 100 transmits the local IP address stored in association with the specifying information, via the Internet 700 to the personal computer 200.

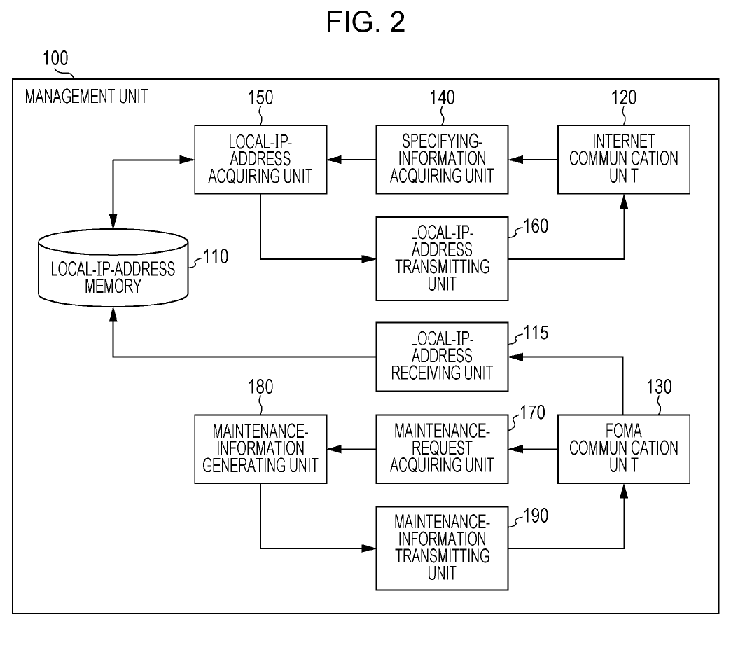

FIG. 2 is a functional block diagram illustrating the management unit 100 according to the exemplary embodiment of the present invention. The management unit 100 includes a local-IP-address receiving unit 115, a local-IP-address memory 110, an Internet communication unit 120, a FOMA communication unit 130, a specifying-information acquiring unit 140, a local-IP-address acquiring unit 150, a local-IP-address transmitting unit 160, a maintenance-request acquiring unit 170, a maintenance-information generating unit 180, and a maintenance-information transmitting unit 190. The local-IP-address receiving unit 115, the Internet communication unit 120, the FOMA communication unit 130, the specifying-information acquiring unit 140, the local-IP-address acquiring unit 150, the local-IP-address transmitting unit 160, the maintenance-request acquiring unit 170, the maintenance-information generating unit 180, and the maintenance-information transmitting unit 190 are implemented as functions of a CPU 104 (see FIG. 4) operating by using programs stored in a storage 105 (see FIG. 4). The local-IP-address memory 110 is implemented by using a storage device such as a memory.

The local-IP-address receiving unit 115 obtains the apparatus ID (specifying information) for specifying an image forming apparatus 300 and the IP address (local IP address) of the image forming apparatus 300 in the LAN communication between the image forming apparatus 300 and the personal computer 200, which are transmitted from the image forming apparatus 300 and which are received by the FOMA communication unit 130, and outputs the apparatus ID and the IP address to the local-IP-address memory 110. The apparatus ID (specifying information) and the local IP address are transmitted from the image forming apparatus 300, for example, when the image forming apparatus 300 is get connected to the LAN.

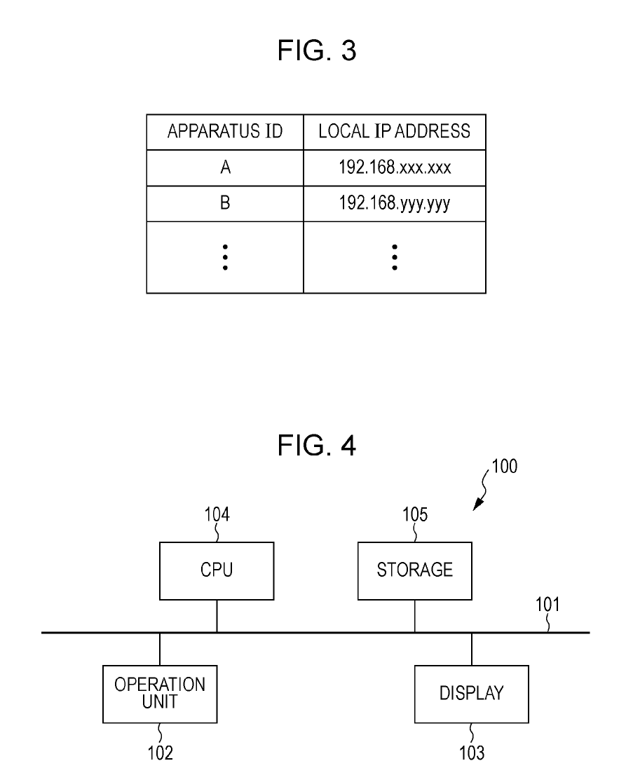

The local-IP-address memory 110 is used to store the apparatus ID (specifying information) for specifying an image forming apparatus 300 and the local IP address of the image forming apparatus 300 which are received from the local-IP-address receiving unit 115, in such a manner that the apparatus ID (specifying information) and the local IP address are associated with each other. FIG. 3 is a diagram illustrating information stored in the local-IP-address memory 110 of the management unit 100 according to the exemplary embodiment of the present invention.

The Internet communication unit 120 which is a block performing communication via the Internet 700 transmits, via the Internet 700, transmission data received from the local-IP-address transmitting unit 160 or the like, and outputs reception data received via the Internet 700, to the specifying-information acquiring unit 140 or the like.

The FOMA communication unit 130 which is a block performing communication via the FOMA network 800 transmits, via the FOMA network 800, transmission data received from the maintenance-information transmitting unit 190 or the like, and outputs reception data received via the FOMA network 800, to the local-IP-address receiving unit 115, the maintenance-request acquiring unit 170, or the like.

The specifying-information acquiring unit 140 acquires the apparatus ID (specifying information) for specifying an image forming apparatus 300, from the local-IP-address request signal which is transmitted from the personal computer 200 and which is received by the Internet communication unit 120.

The local-IP-address acquiring unit 150 searches data stored in the local-IP-address memory 110, and obtains the local IP address stored in association with the apparatus ID obtained from the specifying-information acquiring unit 140.

The local-IP-address transmitting unit 160 transmits the local IP address acquired by the local-IP-address acquiring unit 150, via the Internet communication unit 120 to the personal computer 200.

The maintenance-request acquiring unit 170 acquires a maintenance request signal which is transmitted from an image forming apparatus 300 and which is received by the FOMA communication unit 130.

The maintenance-information generating unit 180 generates maintenance information with which the image forming apparatus 300 performs a maintenance operation, in accordance with the maintenance request signal acquired by the maintenance-request acquiring unit 170.

The maintenance-information transmitting unit 190 transmits the maintenance information generated by the maintenance-information generating unit 180, via the FOMA communication unit 130 to the image forming apparatus 300.

FIG. 4 is a block diagram illustrating the hardware configuration of the management unit 100 according to the exemplary embodiment of the present invention. The management unit 100 includes an operation unit 102, a display 103, the CPU 104, and the storage 105 which are connected to each other through a bus 101. The operation unit 102 which is, for example, a keyboard or a mouse receives an operation performed by an operator of the management unit 100. The display 103 is a display apparatus such as a liquid crystal display. The CPU 104 operates by using the programs stored in the storage 105. The storage 105 includes a storage device, such as a hard disk or a memory.

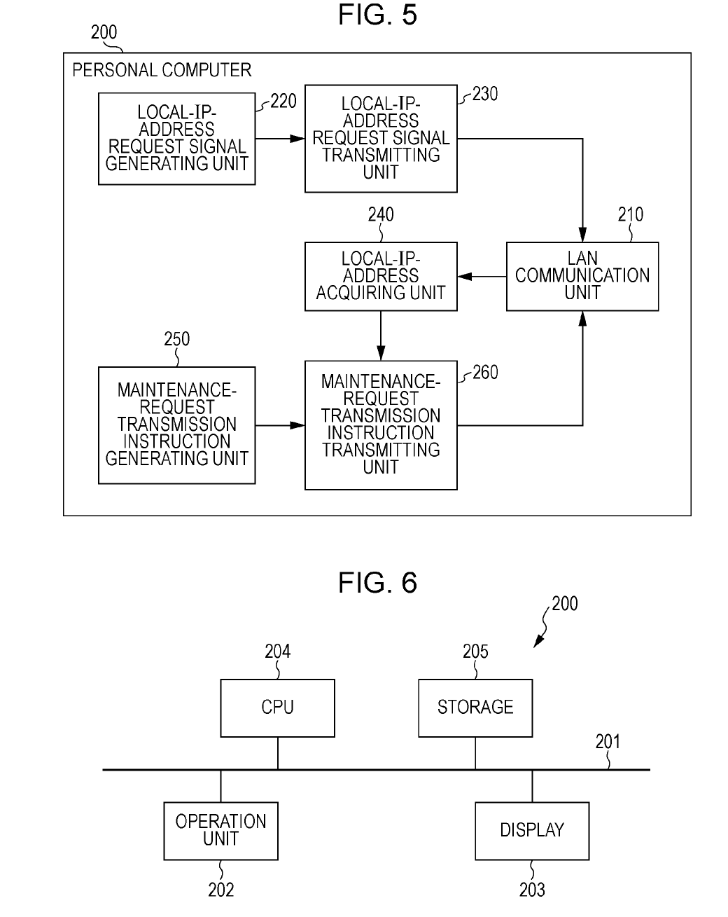

FIG. 5 is a functional block diagram illustrating the personal computer 200 according to the exemplary embodiment of the present invention. The personal computer 200 includes a LAN communication unit 210, a local-IP-address request signal generating unit 220, a local-IP-address request signal transmitting unit 230, a local-IP-address acquiring unit 240, a maintenance-request transmission instruction generating unit 250, and a maintenance-request transmission instruction transmitting unit 260. The LAN communication unit 210, the local-IP-address request signal generating unit 220, the local-IP-address request signal transmitting unit 230, the local-IP-address acquiring unit 240, the maintenance-request transmission instruction generating unit 250, and the maintenance-request transmission instruction transmitting unit 260 are implemented as functions of a CPU 204 (see FIG. 6) operating by using programs stored in a storage 205 (see FIG. 6).

The LAN communication unit 210 which is a block achieving LAN communication transmits transmission data received from the local-IP-address request signal transmitting unit 230, the maintenance-request transmission instruction transmitting unit 260, and the like through the LAN communication, and outputs reception data received through the LAN communication, to the local-IP-address acquiring unit 240 and the like.

The local-IP-address request signal generating unit 220 generates a local-IP-address request signal to request the IP address (local IP address) of an image forming apparatus 300 in the LAN communication, from the management unit 100 on the basis of an operation performed by a user of the personal computer 200.

The local-IP-address request signal transmitting unit 230 transmits the local-IP-address request signal generated by the local-IP-address request signal generating unit 220, via the LAN communication unit 210 to the management unit 100 on the basis of the operation performed by the user of the personal computer 200.

The local-IP-address acquiring unit 240 acquires the local IP address of the image forming apparatus 300 which is transmitted from the management unit 100 in accordance with a local-IP-address request signal and which is received by the LAN communication unit 210.

The maintenance-request transmission instruction generating unit 250 generates a maintenance-request transmission instruction to instruct an image forming apparatus 300 to transmit a maintenance request to the management unit 100, on the basis of an operation performed by the user of the personal computer 200.

The maintenance-request transmission instruction transmitting unit 260 transmits the maintenance-request transmission instruction generated by the maintenance-request transmission instruction generating unit 250, by using the local IP address acquired by the local-IP-address acquiring unit 240, via the LAN communication unit 210 through the LAN communication to the image forming apparatus 300.

FIG. 6 is a block diagram illustrating the hardware configuration of the personal computer 200 according to the exemplary embodiment of the present invention. The personal computer 200 includes an operation unit 202, a display 203, the CPU 204, and the storage 205 which are connected to each other via a bus 201. The operation unit 202 which is, for example, a keyboard or a mouse receives an operation performed by an operator of the personal computer 200. The display 203 is a display apparatus such as a liquid crystal display. The CPU 204 operates by using the programs stored in the storage 205. The storage 205 includes a storage device, such as a hard disk or a memory.

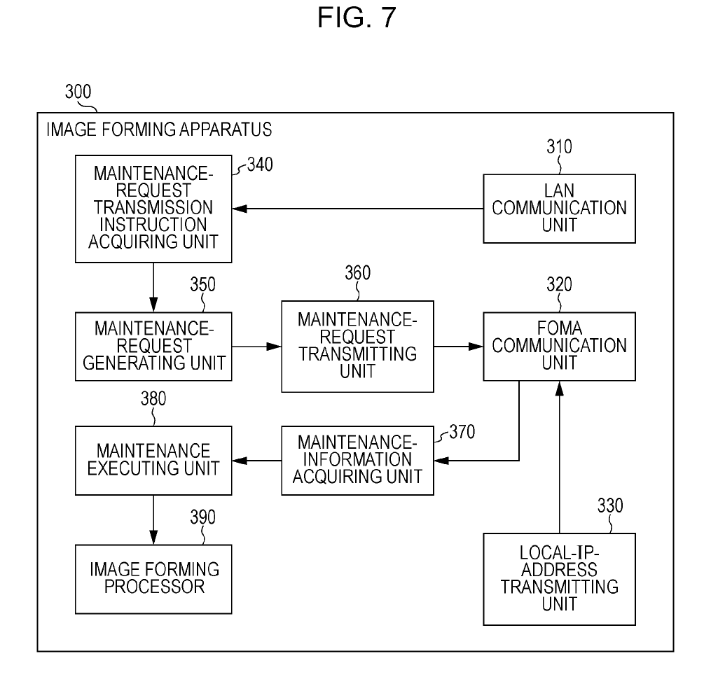

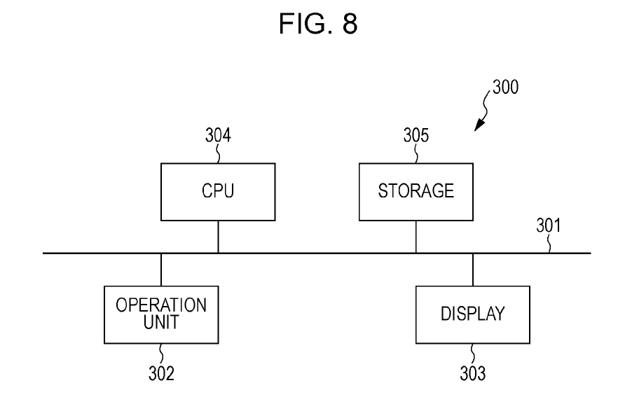

FIG. 7 is a functional block diagram illustrating the configuration of an image forming apparatus 300 according to the exemplary embodiment of the present invention. The image forming apparatus 300 includes a LAN communication unit 310, a FOMA communication unit 320, a local-IP-address transmitting unit 330, a maintenance-request transmission instruction acquiring unit 340, a maintenance-request generating unit 350, a maintenance-request transmitting unit 360, a maintenance-information acquiring unit 370, a maintenance executing unit 380, and an image forming processor 390. The LAN communication unit 310, the FOMA communication unit 320, the local-IP-address transmitting unit 330, the maintenance-request transmission instruction acquiring unit 340, the maintenance-request generating unit 350, the maintenance-request transmitting unit 360, the maintenance-information acquiring unit 370, the maintenance executing unit 380, and the image forming processor 390 are implemented as functions of a CPU 304 (see FIG. 8) operating by using programs stored in a storage 305 (see FIG. 8).

The LAN communication unit 310 which is a block performing LAN communication outputs reception data received through the LAN communication, to the maintenance-request transmission instruction acquiring unit 340 and the like.

The FOMA communication unit 320 which is a block performing communication via the FOMA network 800 transmits transmission data received from the local-IP-address transmitting unit 330, the maintenance-request transmitting unit 360, and the like, via the FOMA network 800, and outputs reception data received via the FOMA network 800, to the maintenance-information acquiring unit 370 and the like.

The local-IP-address transmitting unit 330 transmits the apparatus ID (specifying information) for specifying the image forming apparatus 300 and the local IP address for identifying the image forming apparatus 300 in the LAN communication, via the FOMA communication unit 320 to the management unit 100, for example, when the image forming apparatus 300 gets connected to the LAN.

The maintenance-request transmission instruction acquiring unit 340 acquires a maintenance-request transmission instruction which is transmitted from the personal computer 200 and which is received by the LAN communication unit 310.

The maintenance-request generating unit 350 generates a maintenance request signal to request maintenance (transmission of maintenance information) from the management unit 100, on the basis of the maintenance-request transmission instruction acquired by the maintenance-request transmission instruction acquiring unit 340.

The maintenance-request transmitting unit 360 transmits the maintenance request signal generated by the maintenance-request generating unit 350, via the FOMA communication unit 320 to the management unit 100.

The maintenance-information acquiring unit 370 acquires maintenance information which is transmitted from the management unit 100 and which is received by the FOMA communication unit 320.

The maintenance executing unit 380 performs a maintenance operation on the image forming processor 390 on the basis of the maintenance information acquired by the maintenance-information acquiring unit 370. The image forming processor 390 performs image forming processing, such as generating of print data based on image data or print processing, on the basis of an operation performed by a user of the image forming apparatus 300. The image forming processor 390 performs a maintenance operation on the basis of the control exerted by the maintenance executing unit 380.

FIG. 8 is a block diagram illustrating the hardware configuration of the image forming apparatus 300 according to the exemplary embodiment of the present invention. The image forming apparatus 300 includes an operation unit 302, a display 303, the CPU 304, and the storage 305 which are connected to each other via a bus 301. The operation unit 302 which is, for example, a keyboard or a mouse receives an operation performed by a user of the image forming apparatus 300. The display 303 is a display apparatus such as a liquid crystal display. The CPU 304 operates by using the programs stored in the storage 305. The storage 305 includes a storage device, such as a hard disk or a memory.

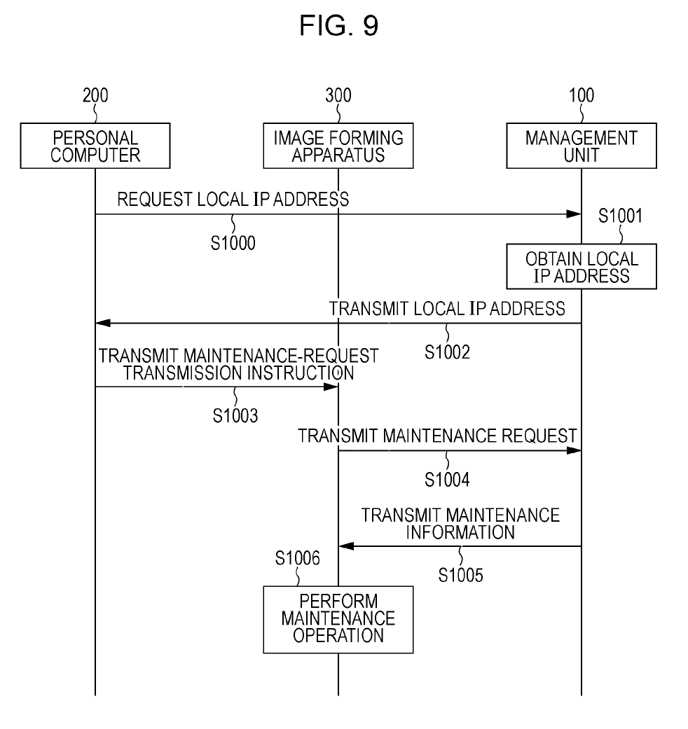

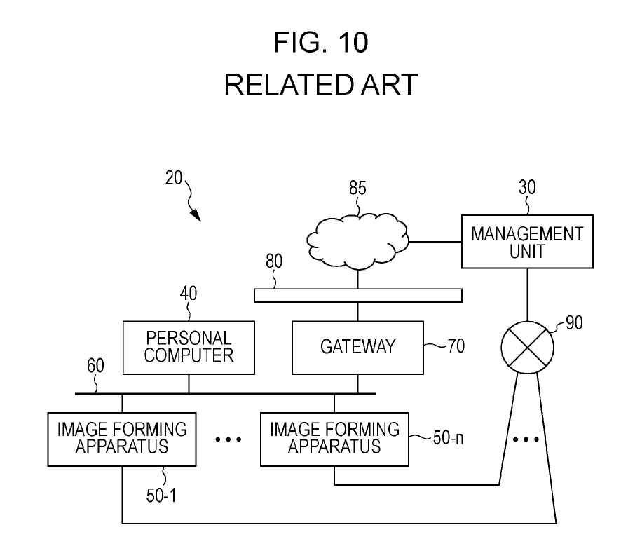

The operations performed in the information processing system 10 will be described by using a sequence chart. FIG. 9 is a sequence chart of operations performed in the information processing system 10 according to the exemplary embodiment of the present invention.

An operation performed by a user who wants to maintain an image forming apparatus 300 causes the personal computer 200 to request the local IP address of the image forming apparatus 300 from the management unit 100 through communication via the Internet 700 (S1000).

The management unit 100 which has received the request for the local IP address refers to the local-IP-address memory 110 to search for and obtain the local IP address (S1001), and transmits the local IP address of the image forming apparatus 300 which has been requested, through communication via the Internet 700 to the personal computer 200 (S1002).

The personal computer 200 uses the local IP address received in S1002, to perform LAN communication with the image forming apparatus 300, and transmits a maintenance-request transmission instruction (S1003).

The image forming apparatus 300 which has received the maintenance-request transmission instruction transmits a maintenance request via the FOMA network 800 to the management unit 100 (S1004).

The management unit 100 which has received the maintenance request transmits maintenance information via the FOMA network 800 to the image forming apparatus 300 (S1005). The image forming apparatus 300 performs a maintenance operation on the basis of the maintenance information received in S1005 (S1006). Then, the operations performed in the information processing system 10 end.

The above-described configuration provides the management unit 100 which stores local IP addresses and which transmits a local IP address to the personal computer 200, and also provides the information processing system 10 including the management unit 100. Thus, prior to transmission of a maintenance-request transmission instruction to an image forming apparatus 300, the personal computer 200 may obtain the local IP address from the management unit 100. Then, the personal computer 200 may transmit the maintenance-request transmission instruction to the image forming apparatus 300 through the LAN communication.

The present invention is not limited to the above-described embodiment. Needless to say, the present invention encompasses an embodiment which is obtained through modification made without departing from the gist of the present invention. For example, in the above-described embodiment, the configuration in which the management unit 100 transmits maintenance information to one image forming apparatus 300 and in which the image forming apparatus 300 performs a maintenance operation is described. The present invention is not limited to this. The following configuration may be employed. The personal computer 200 obtains the local IP addresses of multiple image forming apparatuses 300, and instructs the multiple image forming apparatuses 300 to transmit maintenance requests which are associated with one another in some way, such as by attaching the identical identification signal. In this way, the management unit 100 transmits the same maintenance information to the multiple image forming apparatuses 300. This configuration allows multiple image forming apparatuses 300 to perform the same maintenance operation.

For example, in the above-described embodiment, the configuration in which the personal computer 200 obtains a local IP address for LAN communication from the management unit 100 is disclosed. The present invention is not limited to this. Any embodiment may be used in which the management unit 100 stores some information necessary for communication between the personal computer 200 and an image forming apparatus 300 and supplies the information to the personal computer 200.

The operations which are performed by the management unit 100, the personal computer 200, and an image forming apparatus 300 and which are described herein are achieved by executing programs stored in the respective storages. The programs may be supplied through communication, or may be supplied through a computer-readable storage medium such as a compact disc-read-only memory (CD-ROM) for storing the programs.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A management unit which communicates with at least one image forming apparatus via a first communication path and which communicates with an information processing apparatus via a second communication path, the information processing apparatus receiving an operation for maintenance for the at least one image forming apparatus, the management unit comprising:
a memory that is used to store specifying information and identification information in such a manner that the specifying information and the identification information are associated with each other, the specifying information being information for specifying the at least one image forming apparatus, the identification information being information for identifying the at least one image forming apparatus in local communication between the information processing apparatus and the at least one image forming apparatus;
a specifying-information acquiring unit that acquires the specifying information from an identification-information request signal transmitted from the information processing apparatus via the second communication path, the specifying information being information for specifying the at least one image forming apparatus which is a target for the maintenance; and
a transmitting unit that transmits the identification information to the information processing apparatus via the second communication path, the identification information being stored in the memory in association with the specifying information acquired by the specifying-information acquiring unit.

2. The management unit according to claim 1,
wherein the identification information stored in the memory is received from the at least one image forming apparatus.

3. The management unit according to claim 1, further comprising:
a maintenance-information transmitting unit that transmits maintenance information to the at least one image forming apparatus via the first communication path in accordance with at least one maintenance request signal received from the at least one image forming apparatus via the first communication path, the maintenance information being information about the maintenance.

4. The management unit according to claim 2, further comprising:
a maintenance-information transmitting unit that transmits maintenance information to the at least one image forming apparatus via the first communication path in accordance with at least one maintenance request signal received from the at least one image forming apparatus via the first communication path, the maintenance information being information about the maintenance.

5. The management unit according to claim 3,
wherein the at least one image forming apparatus includes a plurality of image forming apparatuses,
wherein the at least one maintenance request signal includes a plurality of maintenance request signals, and
wherein the maintenance-information transmitting unit transmits the identical maintenance information to the plurality of image forming apparatuses in accordance with the plurality of maintenance request signals received from the plurality of image forming apparatuses.

6. The management unit according to claim 4,
wherein the at least one image forming apparatus includes a plurality of image forming apparatuses,
wherein the at least one maintenance request signal includes a plurality of maintenance request signals, and
wherein the maintenance-information transmitting unit transmits the identical maintenance information to the plurality of image forming apparatuses in accordance with the plurality of maintenance request signals received from the plurality of image forming apparatuses.

7. The management unit according to claim 3,
wherein the maintenance information includes information for setting customer information in the at least one image forming apparatus.

8. The management unit according to claim 4,
wherein the maintenance information includes information for setting customer information in the at least one image forming apparatus.

9. The management unit according to claim 5,
wherein the maintenance information includes information for setting customer information in the plurality of image forming apparatuses.

10. The management unit according to claim 6,
wherein the maintenance information includes information for setting customer information in the plurality of image forming apparatuses.

11. The management unit according to claim 3,
wherein the maintenance information includes information for setting operation information of the at least one image forming apparatus.

12. The management unit according to claim 4,
wherein the maintenance information includes information for setting operation information of the at least one image forming apparatus.

13. The management unit according to claim 5,
wherein the maintenance information includes information for setting operation information of the plurality of image forming apparatuses.

14. The management unit according to claim 6,
wherein the maintenance information includes information for setting operation information of the plurality of image forming apparatuses.

15. The management unit according to claim 7,
wherein the maintenance information includes information for setting operation information of the at least one image forming apparatus.

16. The management unit according to claim 8,
wherein the maintenance information includes information for setting operation information of the at least one image forming apparatus.

17. The management unit according to claim 9,
wherein the maintenance information includes information for setting operation information of the plurality of image forming apparatuses.

18. The management unit according to claim 10,
wherein the maintenance information includes information for setting operation information of the plurality of image forming apparatuses.

19. An information processing system comprising:
an image forming apparatus;
an information processing apparatus that receives an operation for maintenance for the image forming apparatus and that performs local communication with the image forming apparatus; and
a management unit that communicates with the image forming apparatus via a first communication path, that communicates with the information processing apparatus via a second communication path, and that transmits maintenance information to the image forming apparatus in accordance with a maintenance-information request signal transmitted from the image forming apparatus,
wherein the management unit includes
a memory that is used to store specifying information and identification information in such a manner that the specifying information and the identification information are associated with each other, the specifying information being information for specifying the image forming apparatus, the identification information being information for identifying the image forming apparatus in the local communication,
a specifying-information acquiring unit that acquires the specifying information from an identification-information request signal transmitted from the information processing apparatus via the second communication path, the specifying information being information for specifying the image forming apparatus which is a target for the maintenance, and
a transmitting unit that transmits the identification information to the information processing apparatus via the second communication path, the identification information being stored in the memory in association with the specifying information acquired by the specifying-information acquiring unit, and
wherein the information processing apparatus includes
an identification-information request signal transmitting unit that transmits the identification-information request signal to the management unit via the second communication path,
a unit that obtains the identification information transmitted via the second communication path from the transmitting unit of the management unit, and
a maintenance-request transmission instruction transmitting unit that transmits a maintenance-request transmission instruction to the image forming apparatus through the local communication by using the identification information, the maintenance-request transmission instruction being an instruction to transmit a maintenance request signal to the management unit.

20. A non-transitory computer readable medium storing a program causing a computer to execute a process for functioning as a management unit which communicates with an image forming apparatus via a first communication path and which communicates with an information processing apparatus via a second communication path, the information processing apparatus receiving an operation for maintenance for the image forming apparatus, the process comprising:
storing specifying information and identification information in such a manner that the specifying information and the identification information are associated with each other, the specifying information being information for specifying the image forming apparatus, the identification information being information for identifying the image forming apparatus in local communication between the information processing apparatus and the image forming apparatus;
acquiring the specifying information from an identification-information request signal transmitted from the information processing apparatus via the second communication path, the specifying information being information for specifying the image forming apparatus which is a target for the maintenance; and
transmitting the identification information to the information processing apparatus via the second communication path, the identification information being stored in association with the acquired specifying information.
